(19) United States
(12) Patent Application Publication
(10) Pub. No.: US 2014/0015826 A1
(43) Pub. Date: Jan. 16, 2014

(54) METHOD AND APPARATUS FOR SYNCHRONIZING AN IMAGE WITH A RENDERED OVERLAY

(71) Applicant: Aaron Licata, San Ramon, CA (US)

(72) Inventor: Aaron Licata, San Ramon, CA (US)

(73) Assignee: NOKIA CORPORATION, Espoo (FI)

(21) Appl. No.: 13/548,834

(22) Filed: Jul. 13, 2012

(51) Int. Cl. G06T 15/00; G09G 5/00

(52) U.S. Cl. 345/419; 345/629

(57) ABSTRACT

A method, apparatus and computer program product provide a synchronized display of an overlay and a video image, such as by outputting the merged overlay and video image as a single output to a display. In this regard, the method, apparatus and computer program product may utilize a mobile terminal to generate a first at least one texture corresponding to at least a portion of an image overlay, to generate a second at least one texture corresponding to a received image, and to merge the first at least one texture and the second at least one texture. By merging the textures to generate a single output image before causing a display device to display the image, the overlay and the video image may present an augmented reality interface that remains in synch between the overlay and the underlying image.

### TECHNOLOGICAL FIELD

An example embodiment of the present invention relates generally to augmented reality displays and, more particularly, to synchronizing an augmented reality overlay with an image.

### BACKGROUND

Advances in technology have allowed for increasingly complex features to be integrated into mobile terminals. Features such as video cameras, location information systems, compasses, gyroscopes, and accelerometers are capable of leveraging the communication capabilities of mobile terminals such as cellular phones, personal digital assistants (PDAs), and smartphones to provide users with unprecedented levels of information. One such way of providing information to a user is via the use of an augmented reality (AR) display. Such displays typically receive and display image data from an image capture device or a video capture device (e.g., a video camera coupled to the mobile terminal) and modify or overlay the image data to impart additional information to the user. For example, an AR display might use compass readings, an internal gyroscope, and an image of a night sky to overlay the night sky with the names of particular constellations. Another AR display might overlay a user's travel route to a destination over a view of a city street to direct the user.

To add the additional information to the source image, AR displays may rely upon a particular process executing on the mobile terminal to generate a layer containing the information and to merge the generated layer with the image received from a device camera. Since generating the layer and displaying it on the image is performed by a separate process from the process that receives the image from the device camera, the underlying camera image and the overlay layer may be generated at different rates, resulting in a merged image that appears jittery and unsynchronized.

### BRIEF SUMMARY

A method, apparatus and computer program product are therefore provided according to an example embodiment of the present invention in order to provide a synchronized display of an overlay and a video image, such as by outputting the merged overlay and video image as a single output to a display. In this regard, the method, apparatus and computer program product of an example embodiment may utilize a mobile terminal to generate a first at least one texture corresponding to at least a portion of an image overlay, to generate a second at least one texture corresponding to a received image, and to merge the first at least one texture and the second at least one texture. By merging the textures to generate a single output image before causing a display device to display the image, the overlay and the video image may present an AR interface that remains synchronized between the overlay and the underlying image.

The use of textures for interface elements also advantageously allows for these interface elements to be modified using a graphics processing unit (GPU), allowing for manipulation and modification of the interface element in a three dimensional space. The GPU may implement the interface elements as objects mapped into a virtual three dimensional space. As the area viewed by a device camera changes, the GPU may render a corresponding section of the virtual three dimensional space. Image data received by the camera may be displayed as a texture mapped into the virtual three dimensional space corresponding to the currently viewed area of the camera. As such, by outputting the appropriate area of the virtual three dimensional space to the device display, both the image received from the camera and the interface elements may be displayed as a single, synchronized display. The additional operations provided by the GPU may further allow for interface elements to be sized, scaled, rotated, or otherwise altered by the GPU in ways that improve visibility and usability of AR features of the mobile terminal.

In some embodiments, the invention may include a method comprising determining, with a processor, at least one overlay element to be displayed as at least a portion of an augmented reality display, causing one or more overlay textures to be generated, the one or more overlay textures corresponding to an image for the at least one overlay element, the one or more overlay textures generated in a format suitable for mapping in a virtual three dimensional environment, causing the one or more overlay textures to be mapped in the virtual three dimensional environment, and causing a merged image to be output as the augmented reality display, the image including at least one overlay texture as mapped in the virtual three dimensional environment.

Additional embodiments of the method may further include receiving sensor data from at least one sensor, determining a physical orientation of a mobile terminal using the sensor data, determining a viewport in the virtual three dimensional environment, the viewport corresponding to the determined physical orientation, and causing the merged image to be generated such that the merged image comprises at least a portion of an area of the virtual three dimensional environment corresponding to the viewport. The method of this embodiment may further include receiving updated sensor data from the at least one sensor, determining a new physical orientation of the mobile terminal using the updated sensor data, and updating the viewport to correspond to the new physical orientation of the mobile terminal. The updated sensor data may reflect a change in the physical orientation of the mobile terminal. In some embodiments, the viewport may correspond to one or more pixels of a display. The method may also include causing the background texture to be fitted to an area of the display.

In some additional embodiments, the method may include receiving camera input from a camera device coupled to the processor, causing a background texture to be generated from the camera input, and causing the background texture to be mapped in the virtual three dimensional environment so that the merged image comprises the background texture and at least one overlay texture. The background texture may be generated in a format suitable for mapping in a virtual three dimensional environment. The one or more overlay textures may be mapped by a graphics processing unit other than the processor. Embodiments of the method may also include causing one or more three dimensional assets to be mapped in the virtual three dimensional space.

Some example embodiments of the invention may include an apparatus comprising at least one processor and at least one memory including computer program instructions. The at least one memory and the computer program instructions may be configured to, with the at least one processor, cause the apparatus at least to determine at least one overlay element to be displayed as at least a portion of an augmented reality display, cause one or more overlay textures to be generated, cause the one or more overlay textures to be mapped in the virtual three dimensional environment the one or more overlay textures corresponding to an image for the at least one overlay element, and cause a merged image to be presented as the augmented reality display, the image including at least one overlay texture as mapped in the virtual three dimensional environment. The one or more overlay textures may be generated in a format suitable for mapping in a virtual three dimensional environment.

Embodiments of the apparatus may further include program instructions configured to, with the at least one processor, receive sensor data from at least one sensor, determine a physical orientation of a mobile terminal using the sensor data, determine a viewport in the virtual three dimensional environment, and cause the merged image to be generated such that the merged image comprises at least a portion of an area of the virtual three dimensional environment corresponding to the viewport. The viewport may correspond to the determined physical orientation. The at least one memory and the computer program instructions may be further configured to, with the at least one processor, receive updated sensor data from the at least one sensor, determine a new physical orientation of the mobile terminal using the updated sensor data, and update the viewport to correspond to the new physical orientation of the mobile terminal. The updated sensor data may reflect a change in the physical orientation of the mobile terminal. The viewport, may correspond to one or more pixels of a display. The apparatus may be further configured to cause the background texture to be fitted the background texture to an area of the display. The at least one memory and the computer program instructions may be further configured to, with the at least one processor, receive camera input from a camera device coupled to the processor, cause a background texture to be generated from the camera input, the background texture generated in a format suitable for mapping in a virtual three dimensional environment, and map the background texture in the virtual three dimensional environment so that the merged image comprises the background texture and at least one overlay texture. The one or more overlay textures may be mapped by a graphics processing unit other than the processor.

Example embodiments of the computer program product may include a computer program product comprising at least one non-transitory computer-readable storage medium bearing computer program instructions embodied therein for use with a computer. The computer program instructions may include program instructions configured to determine at least one overlay element to be displayed as at least a portion of an augmented reality display, cause one or more overlay textures to be generated, cause the one or more overlay textures to be mapped in the virtual three dimensional environment, and cause a merged image to be presented by as the augmented reality display, the image including at least one overlay texture as mapped in the virtual three dimensional environment. The one or more overlay textures may correspond to an image for the at least one overlay element. The one or more overlay textures may be generated in a format suitable for mapping in a virtual three dimensional environment.

Embodiments of the computer program product may further include program instructions configured to receive sensor data from at least one sensor, determine a physical orientation of a mobile terminal using the sensor data, determine a viewport in the virtual three dimensional environment, the viewport corresponding to the determined physical orientation, and generate the merged image such that the merged image comprises at least a portion of an area of the virtual three dimensional environment corresponding to the viewport. The program instructions may further include program instructions configured to receive updated sensor data from the at least one sensor, determine a new physical orientation of the mobile terminal using the updated sensor data, and update the viewport to correspond to the new physical orientation of the mobile terminal. The updated sensor data may reflect a change in the physical orientation of the mobile terminal. The computer program product may also include program instructions further comprise program instructions configured to fit the background texture to an area of a display. The computer program product may include program instructions configured to receive camera input from a camera device coupled to the processor, cause a background texture to be generated from the camera input, the background texture generated in a format suitable for mapping in a virtual three dimensional environment, and mapping the background texture in the virtual three dimensional environment so that the merged image comprises the background texture and at least one overlay texture.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with an example embodiment of the present invention;

FIG. 2 is a block diagram illustrating a communication flow between a central processing unit and a graphics processing unit which are specifically configured in accordance with an example embodiment of the present invention;

FIG. 3 is a schematic diagram illustrating an example of a virtual three dimensional space within which interface elements may be mapped in accordance with an example embodiment of the present invention;

FIG. 4 is a block diagram depicting an example rendering path for display of an AR interface combining at least one interface element with an image received from an image capture device in accordance with an example embodiment of the present invention;

FIG. 5 is a block diagram depicting an example rendering path for display of an AR interface combining at least one interface element, at least one three dimensional asset, and an image received from an image capture device in accordance with an example embodiment of the present invention; and

FIG. 6 is a flow diagram depicting an example of a method for displaying an AR interface in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment of the present invention in order to display an AR interface on a display device, such as a display device coupled to a mobile terminal. In this regard, a method, apparatus and computer program product of an example embodiment may convert one or more interface elements of an AR overlay into at least one first texture, convert an image received via an image capture device to at least one second texture, and use the first texture and the second texture to display an overlaid image combining the interface elements with the image received from the image capture device. The overlaid image may be displayed by generating a three dimensional representation of the space around the mobile terminal, and mapping the first and second textures at appropriate locations within the three dimensional representation. For the purposes of the instant disclosure, the term “texture” is generally understood to have its plain and ordinary meaning as when used in the field of three dimensional graphics. Specifically, the term “texture” may describe an image (e.g., a bitmap or raster image) presented in a format suitable for application to a surface or polygon for the purpose of generating an image of a three dimensional space.

The area of the three dimensional representation that is displayed may correspond to a physical position and/or orientation of the mobile terminal in space. In some of the embodiments, the overlaid image may be generated by receiving data over a network. The received data may correspond to a particular physical location of the mobile terminal, a particular query initiated by a user of the mobile terminal, or any other relevant data capable of being displayed as part of an AR interface.

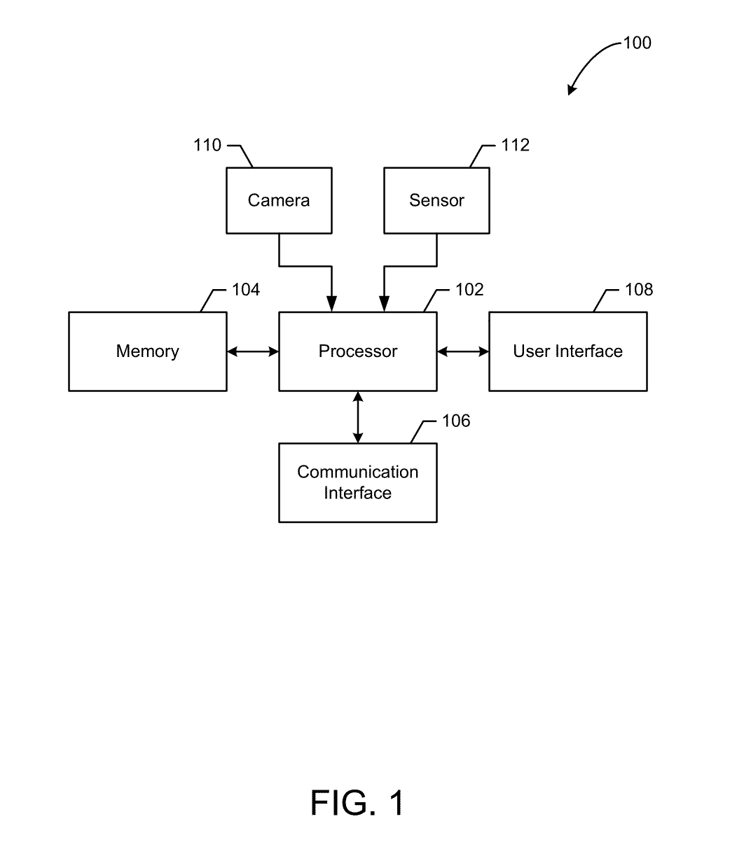

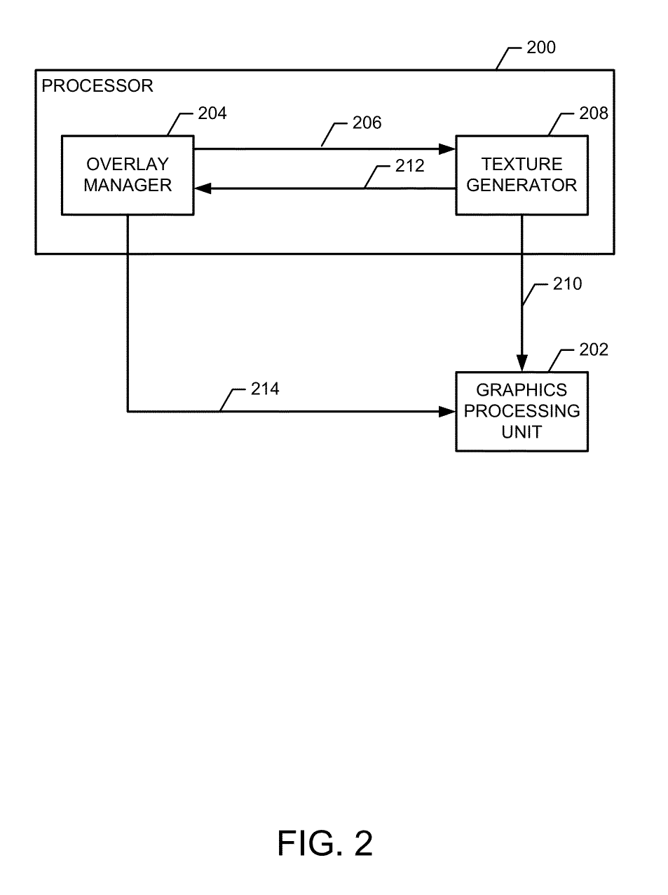

The system of an embodiment of the present invention may include an apparatus 100 as generally described below in conjunction with FIG. 1 for performing one or more of the operations set forth by FIGS. 2-6 and also described below. In this regard, the apparatus 100 may be embodied by a mobile terminal. In this embodiment, the mobile terminal may be in communication with a display and/or a data network, either directly, such as via a wireless or wireline connection, or indirectly via one or more intermediate computing devices. In this regard, the display and the mobile terminal may be parts of the same system in some embodiments. However, the apparatus 100 may alternatively be embodied by another computing device that is in communication with the display and the mobile terminal, such as via a wireless connection, a wireline connection or the like. For example, the apparatus may be a mobile telephone, a personal digital assistant (PDA), a pager, a laptop computer, a tablet computer or any of numerous other hand held or portable communication devices, computation devices, content generation devices, content consumption devices or combinations thereof.

It should also be noted that while FIG. 1 illustrates one example of a configuration of an apparatus 100 for generating an AR interface, numerous other configurations may also be used to implement other embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 1, the apparatus 100 for generating an AR interface in accordance with one example embodiment may include or otherwise be in communication with one or more of a processor 102, a memory 104, a communication interface 106, a user interface 108, a camera 110 and a sensor 112. In some embodiments, the processor (and/or co-processors or any other processing circuitry assisting or otherwise associated with the processor) may be in communication with the memory device via a bus for passing information among components of the apparatus. The memory device may include, for example, a non-transitory memory, such as one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

In some embodiments, the apparatus 100 may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 102 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 102 may be configured to execute instructions stored in the memory device 104 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 106 may be any means such as a device or circuitry embodied in either hardware or a combination of hardware and software that is configured to receive and/or transmit data from/to a network and/or any other device or module in communication with the apparatus 100, such as by supporting communications with a display and/or a mobile terminal. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

The apparatus 100 may include a user interface 108 that may, in turn, be in communication with the processor 102 to provide output to the user and, in some embodiments, to receive an indication of a user input. For example, the user interface may include a display and, in some embodiments, may also include a keyboard, a mouse, a joystick, a touch screen, touch areas, soft keys, a microphone, a speaker, or other input/output mechanisms. In one embodiment, the display of the apparatus may be embodied by a liquid crystal display (LCD) screen presented on one surface of the mobile terminal. For example, in an instance in which the display is an LCD screen embodied on one surface of the mobile terminal, the AR interface may be displayed on the screen for viewing by and interacting with the user of the mobile terminal. As the mobile terminal moves in physical space, the AR interface displayed on the screen may update as visual input to the mobile terminal changes. The processor 102 may comprise user interface circuitry configured to control at least some functions of one or more user interface elements such as a display and, in some embodiments, a speaker, ringer, microphone and/or the like. The processor 102 and/or user interface circuitry comprising the processor 102 may be configured to control one or more functions of one or more user interface elements through computer program instructions (e.g., software and/or firmware) stored on a memory accessible to the processor (e.g., memory 104, and/or the like).

In some example embodiments, the apparatus 100 may include an image capturing element, such as a camera 110, video and/or audio module, in communication with the processor 102. The image capturing element may be any means for capturing an image, video and/or audio for storage, display or transmission. For example, in an example embodiment in which the image capturing element is a camera, the camera may include a digital camera capable of forming a digital image file from a captured image. As such, the camera may include all hardware (for example, a lens or other optical component(s), image sensor, image signal processor, and/or the like) and software necessary for creating a digital image file from a captured image. Alternatively, the camera may include only the hardware needed to view an image, while a memory device 104 of the apparatus stores instructions for execution by the processor in the form of software necessary to create a digital image file from a captured image. In an example embodiment, the camera 110 may further include a processing element such as a co-processor which assists the processor in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

As shown in FIG. 1, the apparatus 100 may also include one or more sensors 112, such as a location information receiver (e.g., a GPS receiver), an accelerometer, a gyroscope, a compass, or the like, that may be in communication with the processor 102 and may be configured to determine the location of the apparatus and to detect changes in motion and/or orientation of the apparatus.

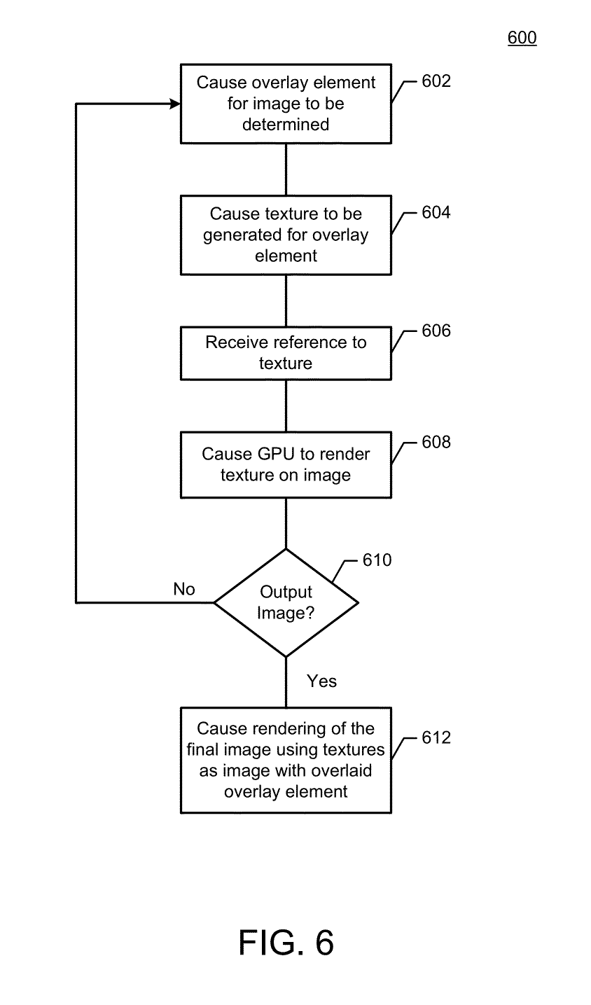

The method, apparatus 100 and computer program product may now be described in conjunction with the operations illustrated in FIGS. 2-6. In this regard, the apparatus may include means, such as the processor 102, the camera 110 or the like, for generating an AR interface. See FIG. 6. The AR interface may be generated in various manners. In some embodiments, the processor 102 may include and/or may execute an overlay manager to receive data about an environment and to determine one or more overlay elements corresponding to the environment. The processor 102 may cause one or more textures to be generated from the overlay elements by executing a texture generator, which, in one embodiment, is also embodied by the processor. In response to causing the one or more textures to be generated, the texture generator may provide one or more references to the overlay manager. The references may describe the one or more generated textures. For example, the references may provide a memory location in system memory or graphics memory of each of the generated textures. Although the texture generator and overlay generator are described as separate processes or applications executed by the processor, both could be implemented as a single application or multiple applications in communication with one another.

The processor 102 may cause a GPU coupled to the apparatus 100 to map a texture in a virtual three dimensional environment at a particular location, the particular location corresponding to the intended display position of the interface element associated with the texture. At particular intervals, the processor 102 may cause the GPU to output an image to a display coupled to the apparatus 100. For example, the GPU may cause a particular portion of the virtual three dimensional environment that corresponds to the physical location and orientation of the device to be displayed, such that a texture corresponding to input received from a camera is rendered along with the interface elements visible in the particular portion of the virtual three dimensional environment to create an overlaid image for display to the user. The processor 102 may further cause the image received from the camera to be converted to a background texture and positioned to fill the display when displaying the virtual three dimensional environment.

FIG. 2 is a block diagram illustrating a communication flow between a processor 200, such as the processor 102 described with respect to FIG. 1, and a GPU 202. The processor 200 and the GPU may be specifically configured in accordance with an example embodiment of the present invention. The processor 200 may execute an overlay manager 204 and a texture generator 208. Although the present embodiment describes the overlay manager 204 and the texture generator 208 as both executing within the processor 200 simultaneously, one or both of these applications may be partially or wholly stored in other memory of the apparatus, such as the memory 102 described with respect to FIG. 1, at any given time.

The overlay manager 204 may be operable to create overlay elements for an AR interface. The overlay manager 204 may be in communication with one or more external elements of a mobile terminal, such as the memory 102, the camera 110, or the sensors 112 described with respect to FIG. 1. For example, the overlay manager 204 may receive location information from a location services device (e.g., a GPS receiver) to identify a current location of the mobile device. The overlay manager 204 may initiate a search query using the current location to identify nearby points of interest proximate to the mobile device (e.g., nearby restaurants, stores, or streets). Using a compass, accelerometers, and/or gyroscopes, the overlay manager may determine the current facing of the mobile device to identify the distance and direction of each of the identified points of interest in relation to a display screen of the mobile device. Upon determination of the location of the points of interest in relation to the mobile device, the overlay manager 204 may generate one or more interface elements corresponding with the points of interest, and determine a coordinate location for display of the interface elements. At action 206, these interface elements may be provided to the texture generator 208.

The texture generator 208 may be operable to receive data related to interface elements generated by the overlay manager 204, such as the interface elements described above, and to generate textures corresponding to the received data. The data may be provided to the texture generator in various formats including, but not limited to, data objects prepared using markup languages such as Extensible Application Markup Language (XAML), Extensible Markup Language (XML), Yet Another Markup Language (YAML), Tool Command Language Tool Kit (Tcl/Tk), or the like. The data may define the size, shape, color, and functionality of the associated interface element. The texture generator 208 uses the provided data to generate one or more textures that relate to a visual representation of the data received from the overlay generator. The texture generator 208 may store the one or more textures in a memory as they are generated. At action 210, the texture generator 208 may store the one or more textures directly in a graphics memory (e.g., memory directly addressable by the GPU 202). Although the instant example embodiment describes the texture generator 208 as storing the textures directly into graphics memory, the textures may also or instead be stored in a system memory, on a hard disk, or in any other combination of memories. Subsequent to or simultaneously with storage of the textures in memory, at action 212 the texture generator 208 may also return a reference, such as a memory address, to the overlay manager, identifying the memory location(s) of the textures.

The GPU 202 may be a specially designed circuit or processor designed for the building of images for display. The GPU 202 may be implemented as part of the architecture of the processor, or via a separate and distinct circuit. The GPU 202 may be specifically matched to the computational requirements of animating images on the device's particular display. For example, unlike the processor 200 which may be designed to perform many tasks, the GPU 202 may be dedicated to display generation. To that end, the GPU 202 may possess special circuitry and/or processing pipelines optimized for performing graphics processing operations, such as texture mapping, rendering of polygons, rotation and translation of vertices, implementation of programmable shaders, antialiasing, anisotropic filtering, and the like.

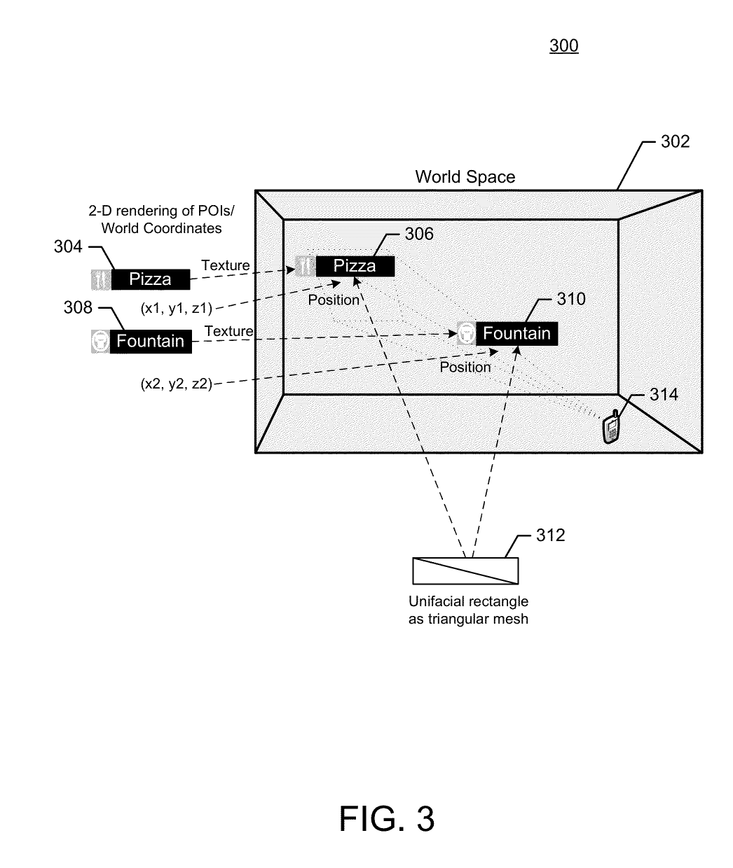

At action 214, the overlay manager 206 may instruct the GPU 202 to render the textures in a virtual three dimensional environment. The overlay manager 206 may instruct the GPU 202 as to which textures to render and their particular locations within the space using the memory reference provided by the texture generator 208. A further description of the process by which interface elements are rendered within the virtual three dimensional space is described below with respect to FIG. 3.

FIG. 3 is a schematic diagram illustrating an example of a virtual three dimensional space 300 within which interface elements may be mapped in accordance with an example embodiment of the present invention. The virtual three dimensional space 300 includes a world space 302, which may be defined by a three dimensional coordinate system (e.g., x, y, z). One or more interface elements may be stored in memory as textures, such as the pizza label 304 and the fountain label 308. Each of the textures may be associated with a particular position in the world space 302, such as by the three coordinate values (x1, y1, z1) associated with the pizza label 304 and the coordinate values (x2, y2, z2) associated with the fountain label 308. The textures 304, 308 may be mapped onto polygon meshes, such as a unifacial rectangle 312. By mapping the texture onto the polygon, the interface element may be moved, resized, manipulated, and otherwise altered as the unifacial rectangle 312 is oriented around the current facing of the mobile terminal.

The virtual three dimensional space 300 may include a viewport 314, which corresponds to a facing of the mobile terminal. For example, as the mobile terminal turns or moves in physical space, a compass, gyroscope, and/or accelerometers coupled to the mobile terminal may register a change in orientation of the mobile terminal. This orientation change may be communicated to the overlay manager, and the overlay manager may notify the GPU to update the facing of the viewport 314 to be directed towards a position and orientation within the virtual three dimensional space 300 that corresponds to the position and orientation of the mobile terminal in the physical world.

To generate the AR interface, an image received from a camera coupled to the mobile terminal may be mapped as a background texture behind textures corresponding to the interface elements visible in the viewfinder of the viewport 314, and the area visible by the viewport 314 may be directed to the display of the mobile terminal as output. Thus, the display of the mobile terminal may include both the interface elements (e.g., the textures mapped onto the polygons that are visible through the viewport) and the input image from the camera as a background behind the visible interface elements.

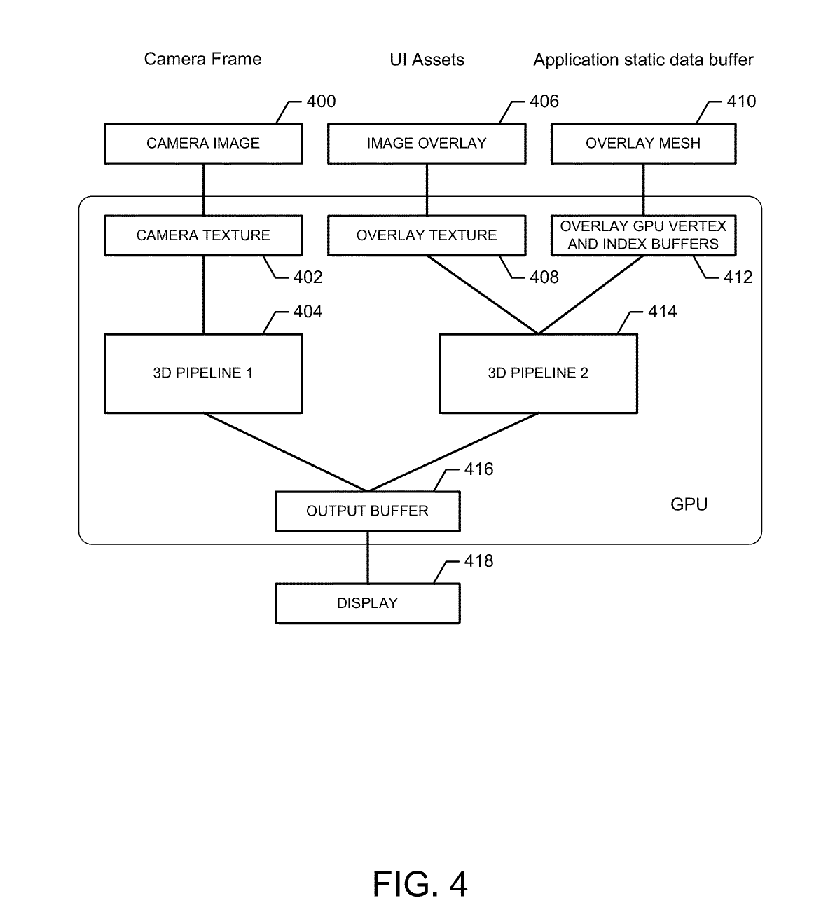

FIG. 4 is a block diagram depicting an example rendering path 400 for display of an AR interface combining at least one interface element with an image received from an image capture device in accordance with an example embodiment of the present invention. The rendering path 400 depicts how data is provided to the GPU for generation of an image for output to a display 418. The rendering path 400 may include three separate data sources, a camera image 400 received from a device camera, interface elements (e.g., labels and icons) corresponding to an image overlay 406, and an overlay mesh 410 (e.g., a polygon at a particular location for mapping of the interface element texture).

The camera image 400 may be converted to a camera texture 402 by the GPU. The camera texture 402 may be processed and rendered by a first 3D pipeline 404 to map the camera texture 402 as a background texture in a virtual space, as described above with respect to FIG. 3. The camera texture 402 may be rendered so as to fill screen area of the mobile terminal corresponding to the viewport 314 (see FIG. 3). The rendered texture may be placed in an output buffer 416, such as a video frame buffer for output to a display 418.

The image overlay 406 may be converted to an overlay texture 408 for rendering by the GPU, such as described above with respect to FIG. 2. Once converted to an overlay texture 408, the GPU may receive instructions to render the overlay texture 408 and map the overlay texture to an overlay mesh 410 in the virtual three dimensional space (e.g., from an overlay manager application as described above with respect to FIG. 2). The GPU may also receive instructions to render the overlay mesh 410 for mapping of the overlay texture, as described with respect to FIG. 3. The overlay mesh 410 may be converted to a set of vertex and index buffers 412 for processing by the GPU. A second 3D pipeline 414 may render the interface element by mapping the overlay texture 408 onto the mesh defined by the overlay vertex and index buffers 412. The interface element may be rendered into the output buffer in a similar manner as the camera texture 402. The combined image in the output buffer, including both the camera texture and the interface elements may be output to the display 418 as an AR interface viewable to the user. Although the instant rendering pipeline does not describe the use of a viewport as described above with respect to FIG. 3, the GPU may also receive instructions (e.g., from an overlay manager) for directing the viewport to determine which overlay elements should be included in the frame buffer, according to various 3D processing techniques.

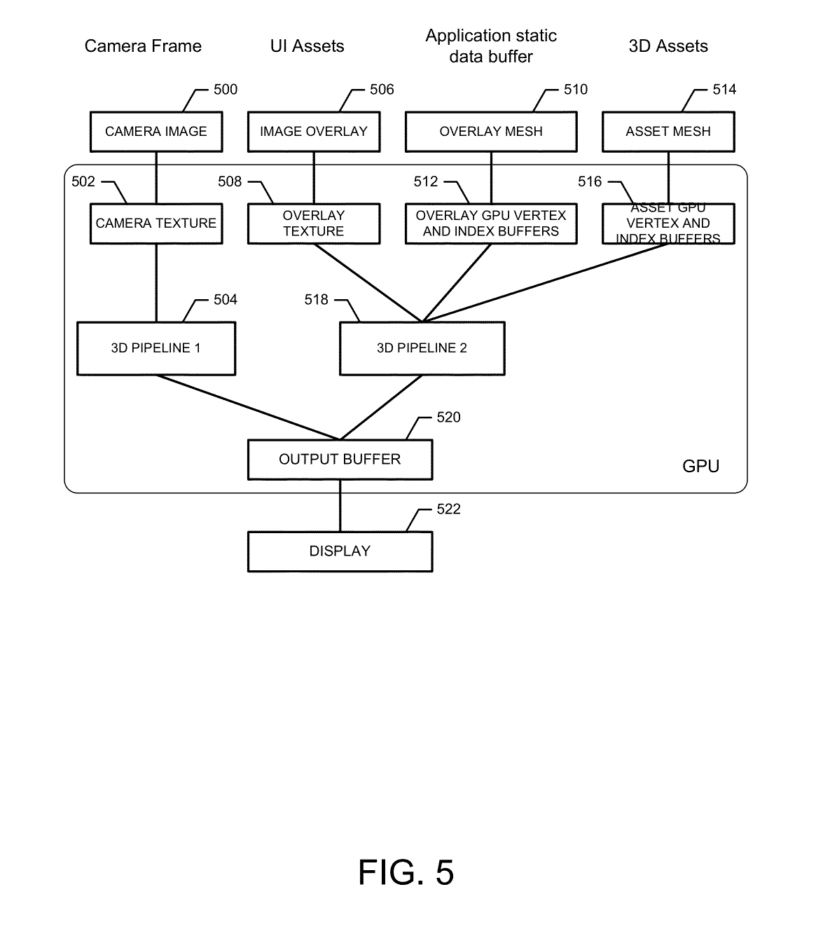

FIG. 5 is a block diagram depicting an example rendering path 500 for display of an AR interface combining at least one interface element, at least one three dimensional asset, and an image received from an image capture device in accordance with an example embodiment of the present invention. For the sake of brevity, like elements of the rendering path 400 described with respect to FIG. 4 will be omitted, such as the rendering path for the camera frame 500, 502, 504, the rendering path for the UI assets 506 and 508, and the rendering path for the application static data buffer 510, 512. In some circumstances, the rendering path may also include three dimensional assets in addition to two dimensional interface elements. For example, an AR interface may include three dimensional icons, labels, game models, or other assets. The use of these assets may allow for crisp results in circumstances where two dimensional images may scale in an unsightly manner, such as in perspective rendering. In such a scenario, these three dimensional assets may be provided to the GPU as a set of meshes 514. These meshes may be converted into a set of asset vertex and index buffers 516, and rendered via the second 3D pipeline 518 along with the overlay texture(s) 508 and the overlay vertex and index buffer(s) 512. The results of this rendering operation may be provided to the output buffer 520 for output to the display 522 as an AR interface.

FIG. 6 illustrates a flowchart of a method 600 according to example embodiments of the invention. The method 600 is operable to display an image overlay merged with a source image to provide an AR interface via a display device. Aspects of the method may include determining one or more elements of the overlay, converting the determined elements into a format suitable for rendering by a GPU, and merging the elements with a source image using the GPU. As described above, elements of the method 600 may be performed by an apparatus, such as the apparatus 100 described with respect to FIG. 1. In some embodiments of the invention, the method 600 may be performed a processing means, such as the processor 200 and/or the GPU 202 described with respect to FIG. 2.

At action 602, the method 600 may cause an overlay element to be determined for an image. As described above, the overlay element may be data that defines one or more parts of an image overlay to be merged with a background image to form an AR interface. For example, the overlay element may be text, an icon, a menu, an image, or another element of the overlay. The overlay element may be determined by various means including the processor or an overlay manager, such as an overlay manager executing on a processor as described with respect to FIG. 2. The overlay manager may receive data from one or more sensing means, such as a sensor or camera coupled to the apparatus, as described with respect to FIG. 1. The received data may be processed to determine which overlay elements should be displayed via the AR interface. For example, nearby streets or restaurants may be labeled with text and/or icons based on the location and orientation of the apparatus. The interface elements may be defined using a data structure according to an interface programming language, such as XAML, XML, Tcl/Tk, or the like.

At action 604, the method 600 may cause one or more textures to be generated for the overlay element. As described above, in some embodiments the textures may be generated by the processing means, such as by the processor or a texture generator executing on a processor as described with respect to FIG. 2. The textures may be generated by causing the texture generator to receive the interface element in a format compatible with the interface programming language. Upon receiving the interface element, the texture generator may be caused to create an image for the interface element suitable for rendering in a three dimensional environment. For example, the texture generator may generate an image in a bitmap or raster image format.

At action 606, the method 600 may receive a reference to the texture caused to be generated at action 604. For example, the processing means, such as the processor, may execute the texture generator to create the texture, and the texture generator may store the texture at a location in a graphics memory or a system memory. Upon storing the texture, the texture generator may provide the memory address of the stored texture to the process or processing means that initiated the texture generation process. For example, an overlay manager may call a function for generating a texture of a particular overlay element, and receive a reference to the texture as a return value to the function. In this regard, means, such as the processor or the overlay element, may be provided for receiving the reference to the texture caused to be generated.

At action 608, the method 600 may cause a GPU, such as the GPU 202 described with respect to FIG. 2, to render the texture as part of an image. For example, the processing means, such as the processor, may instruct the GPU to map the texture onto a mesh at a particular location within a virtual three dimensional space, such as described with respect to FIG. 3. The GPU may be provided with the texture and the intended location of the texture within the virtual three dimensional space.

At action 610, the method 600 determines whether to output and/or update a displayed image corresponding to the AR interface. The processing means, such as the processor and/or the GPU, may include one or more monitor/update threads for controlling updating of the display. For example, a first update thread may track updates to the virtual three dimensional space, such as the appearance of new points of interest, locations, labels, icons, or interface elements. As these new elements are added to the overlay, the first update thread may inform the GPU that the virtual three dimensional space should be updated to reflect changes to the overlay elements.

A second update thread may track actual updates to an output frame buffer used to display a combined image via a display means, such as an LCD screen coupled to a mobile terminal. This second update thread may contain a limited number of instructions for the purpose of maintaining a smooth refresh rate of the display means. The first update thread and the second update thread may operate at different priorities. For example, in scenarios where multiple changes or complex changes are made to the virtual environment, the second update thread might be starved of processor resources if the two threads were executing at the same priority. This might result in the interface appearing to “freeze” or otherwise become unresponsive. By executing the second update thread at a higher priority than the first update thread, the display will continue to refresh and provide a consistent user experience.

At action 612, the image including both the overlay element and a background image is caused, such as by processing means including the processor and/or the GPU, to be output via a display means, such as a display device (e.g., a monitor, LCD screen, television, a video file stored in memory) coupled to the mobile terminal. The image may be output to a display buffer accessible to the display means. The method 600 may repeat to generate a new image at a periodic rate, such as to enable output of an image at 24 frames per second, 30 frames per second, or according to any other refresh rate. Although the instant example method 600 describes an initial generation of an image featuring a combined overlay and background, the same or similar methods may be equally applicable to updating a previously generated image or three dimensional world space, such as in circumstances where overlay elements are added, removed, or modified. For example, a mobile terminal may change physical location, resulting in new points of interest being in physical proximity to the terminal. As such, the method 600 may function to remove overlay elements that are no longer in physical proximity to the mobile terminal (e.g., by removing the associated textures and meshes from the virtual three dimensional environment) and adding new overlay elements corresponding to newly proximate points of interest.

It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining, with a processor, at least one overlay element to be displayed as at least a portion of an augmented reality display;
causing one or more overlay textures to be generated, the one or more overlay textures corresponding to an image for the at least one overlay element, the one or more overlay textures generated in a format suitable for rendering in a virtual three dimensional environment;
causing the one or more overlay textures to be mapped in the virtual three dimensional environment; and
causing a merged image to be output as the augmented reality display, the image including at least one overlay texture as mapped in the virtual three dimensional environment.

2. The method of claim 1, further comprising:
receiving sensor data from at least one sensor;
determining a physical orientation of a mobile terminal using the sensor data;
determining a viewport in the virtual three dimensional environment, the viewport corresponding to the determined physical orientation; and
causing the merged image to be generated such that the merged image comprises at least a portion of an area of the virtual three dimensional environment corresponding to the viewport.

3. The method of claim 2, further comprising:
receiving updated sensor data from the at least one sensor, the updated sensor data reflecting a change in the physical orientation of the mobile terminal;
determining a new physical orientation of the mobile terminal using the updated sensor data; and
updating the viewport to correspond to the new physical orientation of the mobile terminal.

4. The method of claim 2, wherein the viewport corresponds to one or more pixels of a display.

5. The method of claim 4, further comprising causing the background texture to be fitted to an area of the display.

6. The method of claim 1, further comprising:
receiving camera input from a camera device coupled to the processor;
causing a background texture to be generated from the camera input, the background texture generated in a format suitable for mapping in a virtual three dimensional environment; and
causing the background texture to be mapped in the virtual three dimensional environment so that the merged image comprises the background texture and at least one overlay texture.

7. The method of claim 1, wherein the one or more overlay textures are mapped by a graphics processing unit other than the processor.

8. The method of claim 1, further comprising causing one or more three dimensional assets to be rendered in the virtual three dimensional space.

9. An apparatus comprising at least one processor and at least one memory including computer program instructions, the at least one memory and the computer program instructions configured to, with the at least one processor, cause the apparatus at least to:
determine at least one overlay element to be displayed as at least a portion of an augmented reality display;
cause one or more overlay textures to be generated, the one or more overlay textures corresponding to an image for the at least one overlay element, the one or more overlay textures generated in a format suitable for mapping in a virtual three dimensional environment;
cause the one or more overlay textures to be mapped in the virtual three dimensional environment; and
cause a merged image to be presented as the augmented reality display, the image including at least one overlay texture as mapped in the virtual three dimensional environment.

10. The apparatus of claim 9, wherein the at least one memory and the computer program instructions are further configured to, with the at least one processor:
receive sensor data from at least one sensor;
determine a physical orientation of a mobile terminal using the sensor data;
determine a viewport in the virtual three dimensional environment, the viewport corresponding to the determined physical orientation; and
cause the merged image to be generated such that the merged image comprises at least a portion of an area of the virtual three dimensional environment corresponding to the viewport.

11. The apparatus of claim 10, wherein the at least one memory and the computer program instructions are further configured to, with the at least one processor:
receive updated sensor data from the at least one sensor, the updated sensor data reflecting a change in the physical orientation of the mobile terminal;
determine a new physical orientation of the mobile terminal using the updated sensor data; and
update the viewport to correspond to the new physical orientation of the mobile terminal.

12. The apparatus of claim 10, wherein the viewport corresponds to one or more pixels of a display.

13. The apparatus of claim 12, further comprising causing the background texture to be fitted the background texture to an area of the display.

14. The apparatus of claim 9, wherein the at least one memory and the computer program instructions are further configured to, with the at least one processor:
receive camera input from a camera device coupled to the processor;
cause a background texture to be generated from the camera input, the background texture generated in a format suitable for mapping in a virtual three dimensional environment; and
map the background texture in the virtual three dimensional environment so that the merged image comprises the background texture and at least one overlay texture.

15. The apparatus of claim 9, wherein the one or more overlay textures are mapped by a graphics processing unit other than the processor.

16. A computer program product comprising at least one non-transitory computer-readable storage medium bearing computer program instructions embodied therein for use with a computer, the computer program instructions comprising program instructions configured to:
determine at least one overlay element to be displayed as at least a portion of an augmented reality display;
cause one or more overlay textures to be generated, the one or more overlay textures corresponding to an image for the at least one overlay element, the one or more overlay textures generated in a format suitable for mapping in a virtual three dimensional environment;
cause the one or more overlay textures to be mapped in the virtual three dimensional environment; and
cause a merged image to be presented by as the augmented reality display, the image including at least one overlay texture as mapped in the virtual three dimensional environment.

17. The computer program product according to claim 16 wherein the program instructions further comprise program instructions configured to:
receive sensor data from at least one sensor;
determine a physical orientation of a mobile terminal using the sensor data;
determine a viewport in the virtual three dimensional environment, the viewport corresponding to the determined physical orientation; and
generate the merged image such that the merged image comprises at least a portion of an area of the virtual three dimensional environment corresponding to the viewport.

18. The computer program product according to claim 17 wherein the program instructions further comprise program instructions configured to:
receive updated sensor data from the at least one sensor, the updated sensor data reflecting a change in the physical orientation of the mobile terminal;
determine a new physical orientation of the mobile terminal using the updated sensor data; and
update the viewport to correspond to the new physical orientation of the mobile terminal.

19. The computer program product according to claim 18 wherein the program instructions further comprise program instructions configured to fit the background texture to an area of a display.

20. The computer program product according to claim 17 wherein the program instructions further comprise program instructions configured to:
receive camera input from a camera device coupled to the processor;
cause a background texture to be generated from the camera input, the background texture generated in a format suitable for mapping in a virtual three dimensional environment; and
map the background texture in the virtual three dimensional environment so that the merged image comprises the background texture and at least one overlay texture.
